(19) United States
(12) Patent Application Publication
(10) Pub. No.: US 2022/0246051 A1
(43) Pub. Date: Aug. 4, 2022

(54) INTERACTIVE INTERACTION MANAGEMENT SYSTEM

(71) Applicant: Faisal Ashfaq Satti Mohammad, Islamabad (PK)

(72) Inventor: Faisal Ashfaq Satti Mohammad, Islamabad (PK)

(21) Appl. No.: 17/612,228

(22) PCT Filed: May 22, 2019
(86) PCT No.: PCT/RU2019/000360

§ 371 Date: Nov. 18, 2021

(51) Int. Cl. G09B 5/00; H04N 7/14

(52) U.S. Cl. CPC G09B 5/00; H04L 67/306; H04N 7/14

(57) ABSTRACT

A system is claimed for managing interactive cooperation, characterised in that a host provides services via audio or video streaming to different groups of participants, and all participants see a profile of the host. Shown on the profile of the host are various programmes with indicators of the progress of said programmes, and also shown is information relating to future programmes, programmes which will begin next week and programmes which are in the inception phase or the completion phase. Participants can select programmes and request to join them and the host can evaluate the participants and decide whether to allow the participant to join the programme, or to justifiably reject the request of the participant. The problem solved by the claimed invention consists in creating a single platform that coordinates a process of interactive cooperation between a host and participants which entails the right to make selections.

### CROSS-REFERENCE TO RELATED APPLICATIONS

This application is a national stage application of the Patent Cooperation Treaty (PCT) international application titled “INTERACTIVE INTERACTION MANAGEMENT SYSTEM”, international application number PCT/RU2019/000360, filed in the Russian Patent Office on May 22, 2019. The specification of the above referenced patent application is incorporated herein by reference in its entirety.

### FIELD OF THE INVENTION

The invention relates to the field of education, and specifically to special means of remote learning, and can be used for organizing a system for managing interactive interaction.

### BACKGROUND

The technical solution for the international patent for the invention “TW201441993 (priority date 1 Nov. 2014) “Training network of the resource interaction system” is well known. This technical solution is characterized by the fact that it provides a system of interaction of network learning resources. On the system side, at least one server host is preloaded with a database of participants, a database of training materials, a management module and a support interface. The enable interface is at least embedded with a learning option, a learning option, a channel option, a creation option, and a group option. The user can use the user end connection device to connect to the host server via the Internet, and can log in to the capabilities interface to enable the functions of learning, teaching, publishing learning materials, creating and group discussion provided by the system according to the user access right. Consequently, the present invention facilitates the user to quickly access educational materials and knowledge via the Internet and integrates the content of educational materials and knowledge into notes or learning resources intended for group learning. The following essential features of this technical solution coincide with the claimed technical solution “Interactive interaction Management System”: this system involves the coordination of participants (students) using the support interface.

However, this technical solution has a number of disadvantages:
this interaction network does not include a person who provides training in the interaction system, therefore, this interaction system does not provide full interaction of participants and distribution of educational material and programs based on the role of each participant;
In this interaction network, the participant does not present a complete picture of the training programs and does not have the right to choose them, which significantly limits the level of interaction of participants.

Thus, the state of the art does not imply the organization of a system of interactive interactions between the presenter and the participants, in which all participants of the system have the right to choose, on the one hand, the participant of the program, and on the other hand, which program to participate in.

As a result, the shortcomings of the technical solution listed above from the state of the art make the process of interactive interaction of participants in remote streaming audio or video training ineffective, since participants do not have a platform for mutual selection (selection) of participants and programs.

### SUMMARY OF THE INVENTION

An Interactive interaction management system.

The invention relates to the field of education, and specifically to special means of remote learning, and can be used for organizing a system for managing interactive interaction.

The claimed technical solution “Interactive interaction management System” allows solving such technical problems as a low level of coordination of participants in interactive interaction, the lack of a single platform for interaction and the right to choose a program or participant in interaction, which makes the process of interactive interaction using audio and video streaming technologies ineffective.

The technical result is achieved by the fact that the interactive interaction management system is characterized by the fact that the presenter provides services through audio or video streaming technology to various groups of participants, characterized in that all participants see the presenter's profile, which presents various programs with progress indicators of these programs, as well as information about programs that will be in the future, will begin next week, are at the initial stage or at the completion stage, and at the same time participants can choose programs, submit applications to join them, and the moderator can evaluate the participants and make a decision on the participant's joining the program or justifiably rejecting the participant's application.

### DETAILED DESCRIPTION OF THE INVENTION

In contrast to the above analogue, the technical solution “Interactive Interaction Management System” claimed for registration allows you to create a specific platform that coordinates the process of interactive interaction of participants in streaming audio and video, in which both participants and the presenter will have the right to choose (select), respectively, the program or participant.

The claimed technical solution “Interactive interaction management System” allows solving such technical problems as a low level of coordination of participants in interactive interaction, the lack of a single platform for interaction and the right to choose a program or participant in interaction, which makes the process of interactive interaction using audio and video streaming technologies ineffective.

Accordingly, the technical result of the claimed technical solution “Interactive interaction management system” is that it allows you to create a certain platform that coordinates the process of interactive interaction of participants in streaming audio and video, in which both participants and the presenter will have the right to choose (select), respectively, the program or participant.

The technical result is achieved by the fact that the interactive interaction management system is characterized by the fact that the presenter provides services through audio or video streaming technology to various groups of participants, characterized in that all participants see the presenter's profile, which presents various programs with progress indicators of these programs, as well as information about programs that will be in the future, will begin next week, are at the initial stage or at the completion stage, and at the same time participants can choose programs, submit applications to join them, and the moderator can evaluate the participants and make a decision on the participant's joining the program or justifiably rejecting the participant's application.

To obtain a technical result, the invention can be carried out as follows. Presenter “A” provides remote services via audio or video streaming to various groups of participants. Participant “B”, wishing to join one or another group of participants, for example, group “C”, refers to profile “A”, selects a program there and sends an application to “A”. “A”, after receiving the application, evaluates “B” and decides on joining “B” to group “C” to participate in the program or reasonably rejects the application. If the application “B” is approved, then “B” joins group “C” and when the time comes for the program of group “C”, “B” receives the service. Thus, all participants in the interactive interaction get the right to choose (select) the program or participant.

The novelty and inventive level of the presented invention consists in the fact that the claimed technical solution “Interactive interaction control system” allows you to create a certain platform that coordinates the process of interactive interaction of participants in streaming audio and video, in which both participants and the presenter will have the right to choose (select), respectively, the program or participant.

I claim:

1. An interactive interaction management system characterized by the fact that the presenter provides services through audio or video streaming technology to various groups of participants, characterized in that all participants see the presenter's profile, which presents various programs with indicators of the progress of these programs, as well as information about programs that will be in the future, will begin next week, are at the initial stage or at the completion stage, and at the same time participants can choose programs, apply to join them, and the moderator can evaluate the participants and make a decision on the participant's joining the program or justifiably rejecting the participant's application.

2. A system of interactive interactions between the presenter and the participants, in which all participants of the system have the right to choose, on the one hand, the participant of the program, and on the other hand, which program to participate in.

3. A method of claim 1, an interactive interaction management system where presenter can create request to join based audio video streaming programs.

4. A method of claim 1, where interactive interaction system participants can see information about request to join based audio video streaming programs.

5. A method of claim 1, where audio and video streaming programs progress indicators are also shown

6. A method of claim 1, where interactive interaction system participants send request to join audio, video streaming program

7. A method of claim 1, where interactive interaction system participants request to join audio, video streaming program and request is accepted or rejected by moderator after evaluation.

8. A method of claim 1, where interactive interaction system participants request to join audio, video streaming program is rejected and rejection is justified by the moderator.
